(19) United States
(12) Patent Application Publication
(10) Pub. No.: US 2025/0117847 A1
(43) Pub. Date: Apr. 10, 2025

(54) SYSTEMS AND METHODS FOR END-TO-END AUTOMATION OF BORROWING BASE CALCULATIONS

(71) Applicant: JPMORGAN CHASE BANK, N.A., New York, NY (US)

(72) Inventors: Jai KARUPPUSWAMY, Naperville, IL (US); Kennedy A. CAPIN, Johns Island, SC (US); Shonda L. LONG, Bondurant, IA (US); Naveen DOULAGAR, Allen, TX (US); Michael PARKER, Golden, CO (US); Kyle P. THOMAS, New York, NY (US); Sulaimannaseer NASURUDEEN, New York, NY (US)

(21) Appl. No.: 18/483,921

(22) Filed: Oct. 10, 2023

(51) Int. Cl. G06Q 40/03

(52) U.S. Cl. CPC G06Q 40/03

(57) ABSTRACT

Systems and methods for end-to-end automation of borrowing base calculations are disclosed. A method may include a borrowing basis computer program: (1) receiving documents for collateral, assets, and liabilities from a borrowing system for a borrower; (2) extracting information for the collateral, assets, and liabilities from the documents; (3) calculating, from the information, a borrowing base for the borrower; (4) sending the borrowing base to the borrower system; (5) receiving, by the borrowing basis computer program, acknowledgement from the borrower system; (6) setting a borrowing limit based on the borrowing base; (7) receiving updated documents for the borrower; (8) extracting updated information from the updated documents; (9) calculating, from the updated information, an updated borrowing base for the borrower; and (10) setting an updated borrowing limit based on the borrowing base.

### BACKGROUND OF THE INVENTION

### 1. Field of the Invention

Embodiments relate to systems and methods for end-to-end automation of borrowing base calculations.

### 2. Description of the Related Art

A borrowing base is the maximum value a borrower can borrow against pledged collateral; the value is a formula tailored to each transaction and a percentage value of the collateral that is pledged. The borrowing base is often constructed by the lender via credit risk officers and field examiners pre-loan origination; post-loan origination, the calculation is often managed by the borrower and verified by collateral specialists and field examiners with separate validation models.

The supporting financial documents that are used by the collateral specialists and field examiners are often received from the borrowers in disparate ways, including emails. The lack of a centralized/secured submission point and single model/system for the calculation and validation of the borrowing base calculation results in increased operational and credit risks such as a high degree of delayed reporting, delayed validation of calculation, and variances in the calculated values. Further, the borrowing base may be based on stale data, leading to a risk to the lender.

### SUMMARY OF THE INVENTION

Systems and methods for end-to-end automation of borrowing base calculations are disclosed. In one embodiment, a method for end-to-end automation of borrowing base calculations may include: (1) receiving, by a borrowing basis computer program, documents for collateral, assets, and liabilities from a borrowing system for a borrower; (2) extracting, from the documents, information for the collateral, assets, and liabilities from the documents; (3) calculating, by the borrowing base computer program and from the information, a borrowing base for the borrower; (4) sending, by the borrowing base computer program, the borrowing base to the borrower system; (5) receiving, by the borrowing basis computer program, acknowledgement from the borrower system; (6) setting, by the borrowing base computer program, a borrowing limit based on the borrowing base; (7) receiving, by the borrowing base computer program, updated documents for the borrower; (8) extracting, by the borrowing base computer program and from the updated documents, updated information; (9) calculating, by the borrowing base computer program and from the updated information, an updated borrowing base for the borrower; and (10) setting, by the borrowing base computer program, an updated borrowing limit based on the borrowing base.

In one embodiment, the method may further include normalizing, by the borrowing basis computer program, the documents into a normalized format; and normalizing, by the borrowing basis computer program, the updated documents into the normalized format.

In one embodiment, wherein the borrowing base computer program calculates the borrowing base by subtracting a value of ineligibles from a value of the collateral and/or assets for the borrower.

In one embodiment, the documents comprise accounts receivable aging reports, accounts payable aging reports, aging reconnaissance reports, equipment valuation, inventory valuation, and/or real property valuation information.

In one embodiment, the method may further include identifying, by the borrowing base computer program, a type of each of the documents using a machine learning model.

In one embodiment, the documents are unstructured documents.

In one embodiment, the machine learning model may be trained with a plurality of document formats to predict a format of each of the documents.

In one embodiment, the extracted information may be stored in a standard document format.

In one embodiment, the documents are received from an accounting system associated with the borrower.

In one embodiment, the method may further include forecasting, by the borrowing base computer program, a future borrowing base based on historical documents for the borrower.

In one embodiment, the method may further include identifying, by the borrowing base computer program, a trend in the borrowing base.

In one embodiment, the updated documents are received periodically.

In one embodiment, the borrowing limit may be updated when the updated borrowing base and the borrowing base differ by more than a threshold amount.

According to another embodiment, a system, may include: a document source for documents for collateral, assets, and liabilities from a borrowing system for a borrower, wherein the documents comprise accounts receivable aging reports, accounts payable aging reports, aging reconnaissance reports, equipment valuation, inventory valuation, and/or real property valuation information; a borrower system for the borrower; a lender electronic device that is configured to receive the documents from the document source, to extract information for the collateral, assets, and liabilities from the documents, to calculate, from the information, a borrowing base for the borrower, to send the borrowing base to the borrower system, to receive acknowledgement from the borrower system, to receive updated documents for the borrower from the document source, to extract updated information from the documents, and to calculate, from the updated information, an updated borrowing base for the borrower; and a loan servicing system that is configured to set a borrowing limit for the borrower based on the borrowing base, and to set an updated borrowing limit for the borrower based on the updated borrowing base.

In one embodiment, the lender electronic device may be further configured to normalize the documents into a normalized format, and to normalize the updated documents into the normalized format.

In one embodiment, the lender electronic device calculates the borrowing base by subtracting a value of ineligibles from a value of the collateral and/or assets for the borrower.

In one embodiment, the lender electronic device may be further configured to identify a type of each of the documents using a machine learning model, wherein the documents are unstructured documents, wherein the machine learning model may be trained with a plurality of document formats to predict a format of each of the documents.

In one embodiment, the document source comprises an accounting system associated with the borrower.

In one embodiment, the lender electronic device may be further configured to forecast a future borrowing base based on historical documents for the borrower.

In one embodiment, the lender electronic device may be further configured to identify a program, and/or a trend in the borrowing base.

In one embodiment, the borrowing limit may be updated when the updated borrowing base and the borrowing base differ by more than a threshold amount.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for end-to-end automation of borrowing base calculations according to an embodiment;

FIG. 2 illustrates a method for end-to-end automation of borrowing base calculations according to an embodiment;

FIG. 3 depicts an exemplary computing system for implementing aspects of the present disclosure.

### DETAILED DESCRIPTION OF PREFERRED EMBODIMENTS

Embodiments relate to systems and methods for end-to-end automation of borrowing base calculations.

Embodiments may implement standardizations/automations to provide a complete, end-to-end, automated process for the calculation, approval and monitoring of the borrowing base. For example, embodiments may (1) provide upload and classification capabilities of the supporting financial documents at the digital portal for the borrowers; (2) automate the ingestion and processing of these unstructured financial documents; (3) implement automated decisioning based on various thresholds. during the processing of the documents; (4) automate the calculation of borrowing base; (5) present the calculated borrowing base certificate to the borrower, and implement an approval workflow for immediate loan availability, provided credit thresholds are met; etc.

Embodiments may reduce operational and credit risks by reducing the calculation to one control calculation that multiple stakeholders agree on pre-origination. In addition, as data that is utilized to run the calculation is stored, trending data may be obtained for business partners to make data-centric decisions more timely and recurring collateral audits completed in a potentially expedited manner.

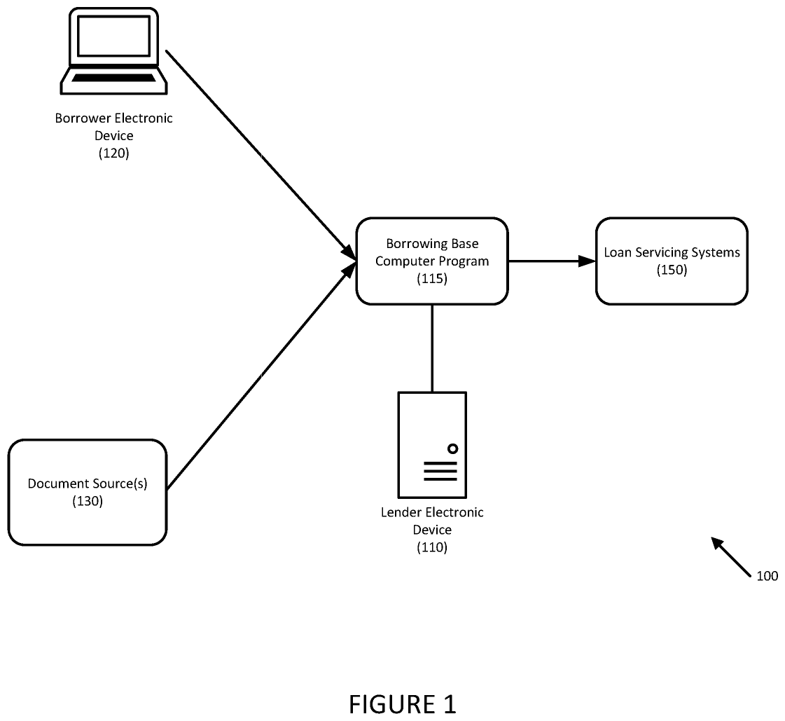

Referring to FIG. 1, a system for end-to-end automation of borrowing base calculations is disclosed according to one embodiment. System 100 may include electronic device 110, which may be a server (e.g., cloud-based and/or physical), computers, etc. Lender electronic device 110 may execute borrowing base computer program 115, which may interface with borrower electronic device 120, document sources 130, and loan servicing systems 150. A lender, using borrower electronic device 120, may receive documents related to collateral, assets, and liabilities, and may calculate a borrowing base for the borrower based on the value of collateral minus the value of ineligibles and/or liabilities.

The documents may be received, for example, from borrower via borrower electronic device 120 and/or from one or more collateral document sources 130. Examples of document sources 130 include systems of record for the borrower, such as accounting platforms, accounting databases, other financial institutions, etc.

The documents may state the value of the collateral, assets, or liabilities. Examples of documents may include accounts receivable aging reports, accounts payable aging reports, aging reconnaissance reports, equipment valuation, inventory valuation, real property valuation information, etc.

The borrowing base computer program may calculate the total ineligibles in various categories such as past due, cross age, aged credits, extended terms, foreign, affiliates etc., and may deduct this from the collateral value for the current reporting period.

Loan servicing system 150 may receive the borrowing basis and may set the revolving credit limit based on the borrowing basis. The credit limit may be updated with each new borrowing basis, when the borrowing basis changes by more than a threshold, etc.

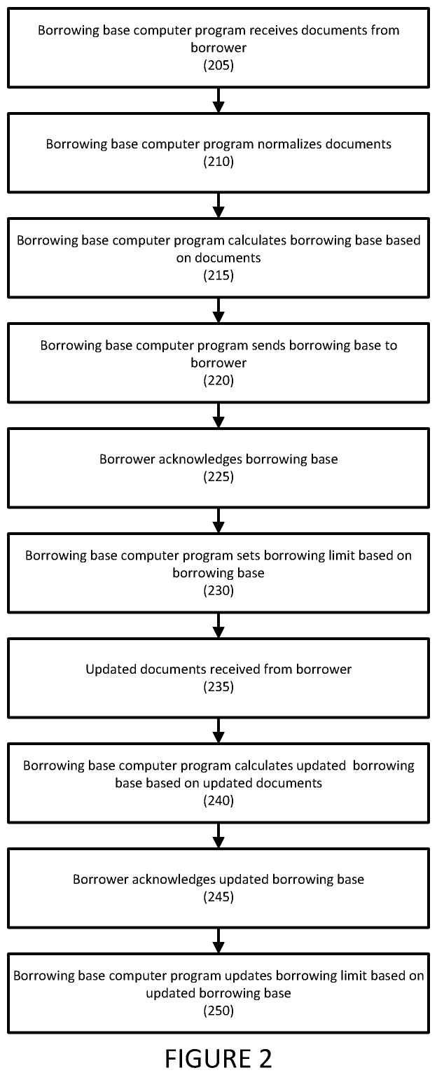

Referring to FIG. 2, a method for end-to-end automation of borrowing base calculations is disclosed according to one embodiment.

In step 205, a computer program, such as a borrowing basis computer program, may receive documents related to a borrower's collateral, assets, and liabilities. The documents may be provided automatically by a borrower system, such as a borrower electronic device, document sources, etc.

For example, the documents may include documents related to accounts receivables, accounts payable, accounting ledgers, etc.

In one embodiment, the documents may be received as unstructured documents.

In step 210, the borrowing base computer program may normalize the documents by converting them into a standard format. For example, the borrowing base computer program may use a machine learning engine that is trained with multiple document formats to identify the document format for each document. It may then extract the relevant fields from the document and may store the extracted information in a different document.

In one embodiment, machine learning may be used to identify the document format for the document. For example, historical collateral documents may be used to train a machine learning engine to identify different fields in the different collateral document formats. Using machine learning, unstructured documents can be processed faster, eliminating errors with a high level of accuracy. This provides the ability to ingest raw accounting data from accounting platforms to increase accuracy of the data and further reduce processing times.

In one embodiment, reconciliation algorithms may be used to verify the accuracy of the extracted data by verifying key financial data fields.

In step 215, the borrowing base computer program may calculate a borrowing base based on collateral documentation. In one embodiment, the borrowing base computer program may calculate the total ineligibles from the documents in various categories such as past due, cross age, aged credits, extended terms, foreign, affiliates etc., and may deduct this from the collateral value for the current reporting period.

Embodiments may enable the parallel processing of documents, running ineligibles calculations, calculating borrowing base to achieve performance efficiency and lower processing times.

Embodiments may also perform trend analysis of ineligibles totals, borrowing bases, and may forecast a future borrowing base limit. This information may be shared with the borrower.

In step 220, the borrowing base computer program may send the borrowing base to the borrower, such as to the borrower electronic device.

In step 225, the borrower may acknowledge the borrowing base using, for example, the borrower electronic device.

In step 230, the borrowing base computer program may set a borrowing limit based on the borrowing base. In one embodiment, the borrowing base computer program may provide the borrowing base to a loan servicing computer program, which may calculate the borrowing limit.

In step 235, the borrower may provide updated collateral documentation. For example, the updated collateral documentation may be received periodically (e.g., daily, weekly, monthly, etc.), on demand, or as otherwise necessary and/or desired.

In one embodiment, the updated collateral documentation may be provided automatically by a borrower system.

The borrowing base computer program may normalize the updated collateral documentation by putting them into a standard format similar to step 210, above.

In step 240, the borrowing base computer program may calculate an updated borrowing base based on the updated collateral documentation.

In step 245, the borrower may acknowledge the updated borrowing base.

In step 250, the borrowing base computer program may update the borrowing limit based on updated borrowing base. This may be similar to step 230, above.

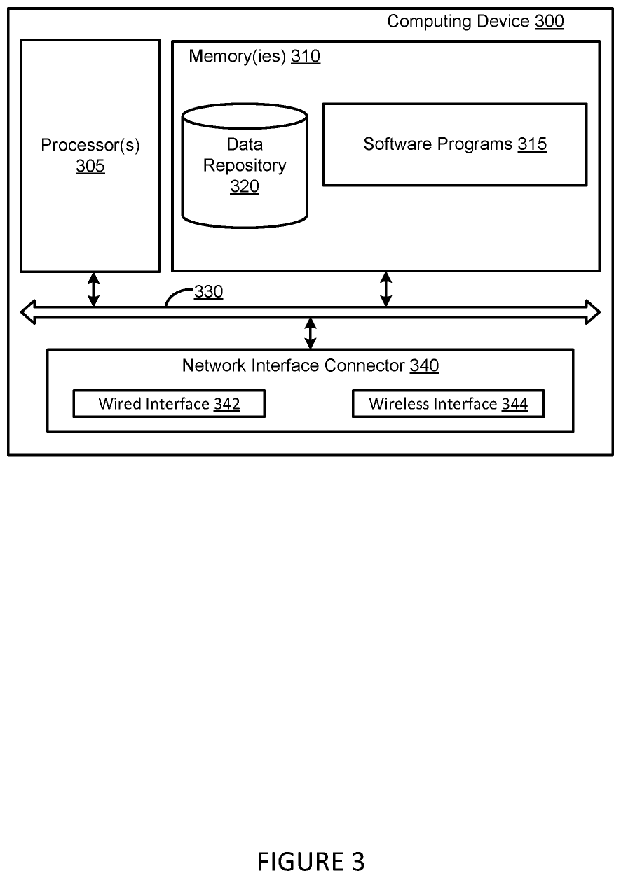

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for end-to-end automation of borrowing base calculations, comprising:
receiving, by a borrowing basis computer program, documents for collateral, assets, and liabilities from a borrowing system for a borrower;
extracting, by the borrowing base computer program, information for the collateral, assets, and liabilities from the documents;
calculating, by the borrowing base computer program and from the information, a borrowing base for the borrower;
sending, by the borrowing base computer program, the borrowing base to the borrower system;
receiving, by the borrowing basis computer program, acknowledgement from the borrower system;
setting, by the borrowing base computer program, a borrowing limit based on the borrowing base;
receiving, by the borrowing base computer program, updated documents for the borrower;
extracting, by the borrowing base computer program, updated information from the updated documents;
calculating, by the borrowing base computer program and from the updated information, an updated borrowing base for the borrower; and
setting, by the borrowing base computer program, an updated borrowing limit based on the borrowing base.

2. The method of claim 1, further comprising:
normalizing, by the borrowing basis computer program, the documents into a normalized format; and
normalizing, by the borrowing basis computer program, the updated documents into the normalized format.

3. The method of claim 1, wherein the borrowing base computer program calculates the borrowing base by subtracting a value of ineligibles from a value of the collateral and/or assets for the borrower.

4. The method of claim 1, wherein the documents comprise accounts receivable aging reports, accounts payable aging reports, aging reconnaissance reports, equipment valuation, inventory valuation, and/or real property valuation information.

5. The method of claim 1, further comprising:
identifying, by the borrowing base computer program, a type of each of the documents using a machine learning model, wherein the documents are unstructured documents.

6. The method of claim 5, wherein the machine learning model is trained with a plurality of document formats to predict a format of each of the documents.

7. The method of claim 1, wherein the extracted information is stored in a standard document format.

8. The method of claim 1, wherein the documents are received from an accounting system associated with the borrower.

9. The method of claim 1, further comprising:
forecasting, by the borrowing base computer program, a future borrowing base based on historical documents for the borrower.

10. The method of claim 1, further comprising:
identifying, by the borrowing base computer program, a trend in the borrowing base.

11. The method of claim 1, wherein the updated documents are received periodically.

12. The method of claim 1, wherein the borrowing limit is updated when the updated borrowing base and the borrowing base differ by more than a threshold amount.

13. A system, comprising:
a document source for documents for collateral, assets, and liabilities from a borrowing system for a borrower, wherein the documents comprise accounts receivable aging reports, accounts payable aging reports, aging reconnaissance reports, equipment valuation, inventory valuation, and/or real property valuation information;
a borrower system for the borrower;
a lender electronic device that is configured to receive the documents from the document source, to extract information for the collateral, assets, and liabilities from the documents, to calculate, from the information, a borrowing base for the borrower, to send the borrowing base to the borrower system, to receive acknowledgement from the borrower system, to receive updated documents for the borrower from the document source, to extract updated information from the documents, and to calculate, from the updated information, an updated borrowing base for the borrower; and
a loan servicing system that is configured to set a borrowing limit for the borrower based on the borrowing base, and to set an updated borrowing limit for the borrower based on the updated borrowing base.

14. The system of claim 13, wherein the lender electronic device is further configured to normalize the documents into a normalized format, and to normalize the updated documents into the normalized format.

15. The system of claim 13, wherein the lender electronic device calculates the borrowing base by subtracting a value of ineligibles from a value of the collateral and/or assets for the borrower.

16. The system of claim 13, wherein the lender electronic device is further configured to identify a type of each of the documents using a machine learning model, wherein the documents are unstructured documents, wherein the machine learning model is trained with a plurality of document formats to predict a format of each of the documents.

17. The system of claim 13, wherein the document source comprises an accounting system associated with the borrower.

18. The system of claim 13, wherein the lender electronic device is further configured to forecast a future borrowing base based on historical documents for the borrower.

19. The system of claim 13, wherein the lender electronic device is further configured to identify program, a trend in the borrowing base.

20. The system of claim 13, wherein the borrowing limit is updated when the updated borrowing base and the borrowing base differ by more than a threshold amount.
